(19) United States
(12) Patent Application Publication
(10) Pub. No.: US 2021/0218784 A1
(43) Pub. Date: Jul. 15, 2021

(54) DETERMINING A COMMUNICATION CHANNEL FOR A MEETING

(71) Applicant: INTERNATIONAL BUSINESS MACHINES CORPORATION, Armonk, NY (US)

(72) Inventors: Reinhold GEISELHART, Rottenburg-Ergenzingen (DE); Alexander LANG, Stuttgart (DE)

(21) Appl. No.: 16/743,454

(22) Filed: Jan. 15, 2020

(51) Int. Cl. H04L 29/06; G06Q 10/10; G06Q 10/06; H04L 12/18; G06N 20/00

(52) U.S. Cl. CPC H04L 65/403; G06Q 10/1095; G06N 20/00; H04L 12/1822; H04L 12/1818; G06Q 10/06314

(57) ABSTRACT

Methods and systems for determining a communication channel for a meeting are disclosed. A method includes: receiving, by a computing device, information about a meeting; determining, by the computing device, a scope of planned collaboration using the received information about the meeting; determining, by the computing device, at least one communication channel for the meeting based on the determined scope of planned collaboration; and presenting, by the computing device, the determined at least one communication channel for the meeting.

### BACKGROUND

Aspects of the present invention generally relate to computing devices and, more particularly, to methods and systems for determining a communication channel for a meeting.

A calendar system may offer the ability to find a best meeting time for a new meeting to be scheduled based on the availability of potential meeting participants as reflected in the calendar system. Information about the availability of potential meeting participants may be enhanced with history information stored in a user's calendar regarding the potential meeting participants' attendance at previous meetings. A calendar system may make a prediction regarding a potential meeting participant's participation in a new meeting based on availability information stored in and retrieved from the calendar system. A meeting may use one or more communication channels. Communication channels may include in-person meetings, telephone conferences, web conferences, chat applications, and virtual reality (VR) conferences.

### SUMMARY

In a first aspect of the invention, there is a method that includes: receiving, by a computing device, information about a meeting; determining, by the computing device, a scope of planned collaboration using the received information about the meeting; determining, by the computing device, at least one communication channel for the meeting based on the determined scope of planned collaboration; and presenting, by the computing device, the determined at least one communication channel for the meeting.

In another aspect of the invention, there is a computer program product that includes: one or more computer readable storage media, and program instructions collectively stored on the one or more computer readable storage media, the program instructions comprising: program instructions to receive historical meeting data from a calendar system; program instructions to, for each meeting in the historical meeting data, determine a meeting timeslot, meeting metadata, and meeting participants; program instructions to determine communication channel preferences using the meeting timeslot, the meeting metadata, and the meeting participants for each meeting in the historical meeting data; and program instructions to store the determined communication channel preferences in a database.

In another aspect of the invention, there is a system that includes: a hardware processor, a computer readable memory, and one or more computer readable storage media associated with a computing device; program instructions to receive information about a meeting; program instructions to determine a scope of planned collaboration using the received information about the meeting; program instructions to determine at least one communication channel for the meeting based on the determined scope of planned collaboration; and program instructions to present the determined at least one communication channel for the meeting, wherein the program instructions are stored on the one or more computer readable storage media for execution by the hardware processor via the computer readable memory.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computer system in accordance with aspects of the invention.

FIG. 2 depicts an illustrative environment in accordance with aspects of the invention.

FIGS. 3 and 4 depict flowcharts of exemplary methods performed in accordance with aspects of the invention.

### DETAILED DESCRIPTION

Aspects of the present invention generally relate to computing devices and, more particularly, to methods and systems for determining a communication channel for a meeting. As described herein, aspects of the invention include a method and system for learning preferences for communication channels based on historical meeting data. Additionally, as described herein, aspects of the invention include a method and system for determining available communication channels for meeting invitees and recommending an optimal communication channel for a meeting.

Calendar systems may make a prediction regarding a potential meeting participant's participation in a new meeting based on availability information stored in and retrieved from the calendar system. However, a meeting organizer may need to choose between a wide variety of communication channels, including in-person meetings (e.g., in a meeting room or at a person's desk), phone conferences, web conferences (e.g., screen sharing applications), chat applications, and meetings supported by VR equipment (e.g., VR glasses and VR data gloves), etc.

While a meeting participant may be available for a meeting at a particular time, the meeting participant may not be able to participate in the meeting using a particular communication channel at the particular time. For example, if the meeting participant is riding in a vehicle at the particular time, the meeting participant may not be able to participate in the meeting using a communication channel such as a web conference, chat application, VR conference, or in-person meeting. However, the meeting participant who is riding in the vehicle may be available to participate in the meeting using a communication channel such as a phone conference.

Certain meetings may require a particular communication channel to be effective (e.g., accomplish an intended purpose). For example, a design review meeting that requires participants to provide feedback on images of potential designs may require an in-person or web conference communication channel to be effective (e.g., so that the images may be viewed by the participants). The design review meeting may not be effective if it is conducted using a telephone or chat application communication channel.

In other cases, different communication channels may be required for different participants in a particular meeting, based on the organizational roles of the participants. For example, in a design review meeting, in order for the meeting to be effective, participants having an organizational role of designer may need to participate in the meeting using an in-person or web conference communication channel (e.g., so that the participants having the organizational role of designer may view images of designs). However, it may not be necessary for other participants in the meeting, such as a participant having an organizational role of program manager, to participate in the meeting using an in-person or web conference communication channel. For these other participants, such as the program manager, participation in the meeting using a communication channel such as a telephone conference or chat application may be sufficient for the meeting to be effective.

Conventional calendar systems may not provide a meeting organizer with guidance regarding which communication channel or combination of communication channels to use for a particular meeting. Additionally, conventional calendar systems may not notify a meeting organizer about a risk that a meeting participant, while available at a particular time, is unable at the particular time to use a particular communication channel required for the meeting to be effective. Additionally, conventional calendar systems may not take into account organizational information such as a meeting participant's roles and responsibility to determine a minimum viable communication channel for the meeting participant in a particular meeting.

Embodiments address these problems with calendar systems by providing methods and systems for determining a communication channel for a meeting. In particular, embodiments improve the functioning of a computer by providing methods and systems for learning preferences for communication channels based on historical meeting data. Additionally, embodiments improve the functioning of a computer by providing methods and systems for determining available communication channels for meeting invitees and recommending an optimal communication channel for a meeting. Accordingly, through the use of rules that improve computer-related technology, implementations of the invention allow computer performance of functions not previously performable by a computer. Additionally, implementations of the invention use techniques that are, by definition, rooted in computer technology (e.g., machine learning, natural language processing, and a lightweight directory access protocol (LDAP) system).

To the extent the implementations collect, store, or employ personal information of individuals, it should be understood that such information shall be used in accordance with all applicable laws concerning protection of personal information. Additionally, the collection, storage, and use of such information may be subject to advance notification and consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

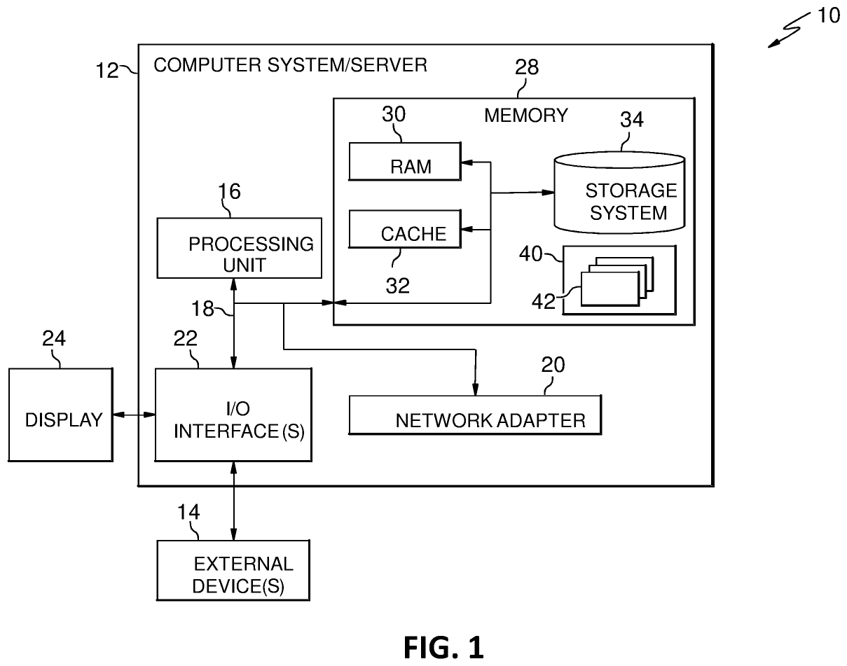

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types.

Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

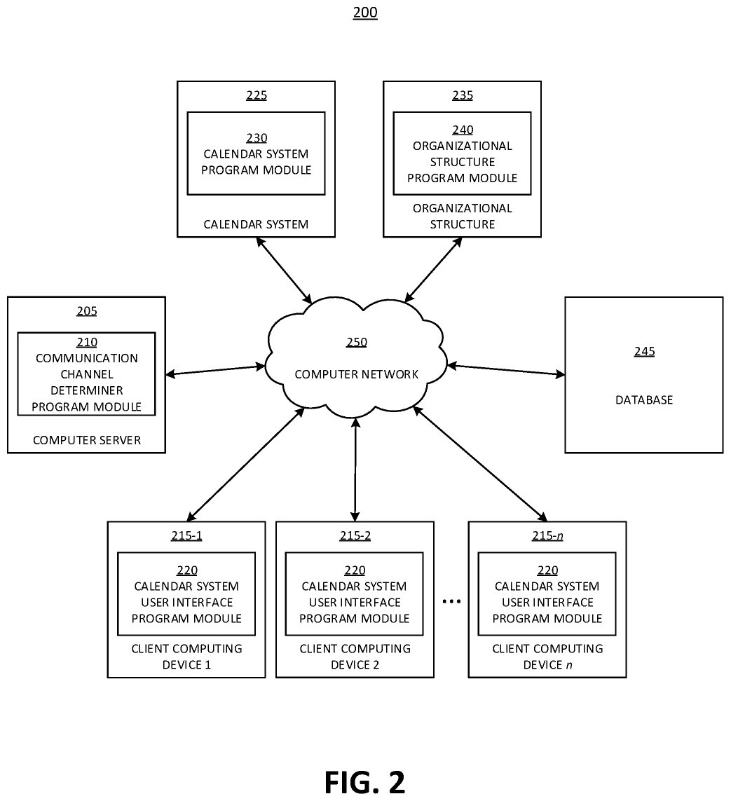

FIG. 2 depicts an illustrative environment 200 in accordance with aspects of the invention. As shown, the environment 200 comprises a computer server 205, a plurality of client computing devices 215-1, 215-2, . . . , 215-n, calendar system 225, organizational structure 235, and database 245 which are in communication via a computer network 250. In embodiments, the computer network 250 is any suitable network including any combination of a LAN, WAN, or the Internet. In embodiments, the computer server 205, the plurality of client computing devices 215-1, 215-2, . . . , 215-n, the calendar system 225, the organizational structure 235, and the database 245 are physically collocated, or, more typically, are situated in separate physical locations.

The quantity of devices and/or networks in the environment 200 is not limited to what is shown in FIG. 2. In practice, the environment 200 may include additional devices and/or networks; fewer devices and/or networks; different devices and/or networks; or differently arranged devices and/or networks than illustrated in FIG. 2. Also, in some implementations, one or more of the devices of the environment 200 may perform one or more functions described as being performed by another one or more of the devices of the environment 200.

In embodiments, the computer server 205 is a computer device comprising one or more elements of the computer system/server 12 (as shown in FIG. 1). In particular, the computer server 205 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

In embodiments, the computer server 205 includes a communication channel determiner program module 210, which comprises one or more of the program modules 42 shown in FIG. 1. In embodiments, the communication channel determiner program module 210 includes program instructions for determining a communication channel for a meeting. In embodiments, the program instructions included in the communication channel determiner program module 210 of the computer server 205 are executed by one or more hardware processors.

Still referring to FIG. 2, in embodiments, each of the plurality of user computing devices 215-1, 215-2, . . . , 215-n is a computer device comprising one or more elements of the computer system/server 12 (as shown in FIG. 1). In other embodiments, each of the plurality of user computing devices 215-1, 215-2, . . . , 215-n is a desktop computer, a laptop computer, a mobile device such as a cellular phone, tablet, personal digital assistant (PDA), or other computing device.

In embodiments, each of the plurality of user computing devices 215-1, 215-2, . . . , 215-n includes calendar system user interface program module 220, which comprises one or more of the program modules 42 shown in FIG. 1. In embodiments, the calendar system user interface program module 220 includes program instructions for a user interface for the calendar system 225. In embodiments, the program instructions included in the calendar system user interface program module 220 of each of the plurality of user computing devices 215-1, 215-2, . . . , 215-n are executed by one or more hardware processors.

Still referring to FIG. 2, in embodiments, the calendar system 225 is a computer device comprising one or more elements of the computer system/server 12 (as shown in FIG. 1). In particular, the calendar system 225 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

In embodiments, the calendar system 225 includes a calendar system program module 230, which comprises one or more of the program modules 42 shown in FIG. 1. In embodiments, the calendar system program module 230 includes program instructions for a calendar system that is accessed by users of the client computing devices 215-1, 215-2, . . . , 215-n using the calendar system user interface program module 220. In embodiments, the program instructions included in the calendar system program module 230 of the calendar system 225 are executed by one or more hardware processors.

Still referring to FIG. 2, in embodiments, the organizational structure 235 is a computer device comprising one or more elements of the computer system/server 12 (as shown in FIG. 1). In particular, the organizational structure 235 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients. In other embodiments, the organizational structure 235 is a server that provides an organizational directory, such as an LDAP server.

In embodiments, the organizational structure 235 includes an organizational structure program module 240, which comprises one or more of the program modules 42 shown in FIG. 1. In embodiments, the organizational structure program module 240 includes program instructions for providing information about an organizational structure in response to a request. In embodiments, the program instructions included in the organizational structure program module 240 of the organizational structure 235 are executed by one or more hardware processors.

Still referring to FIG. 2, in embodiments, the database 245 is a database that stores communication channel preferences for a plurality of users of the calendar system 225. In embodiments, the database 245 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

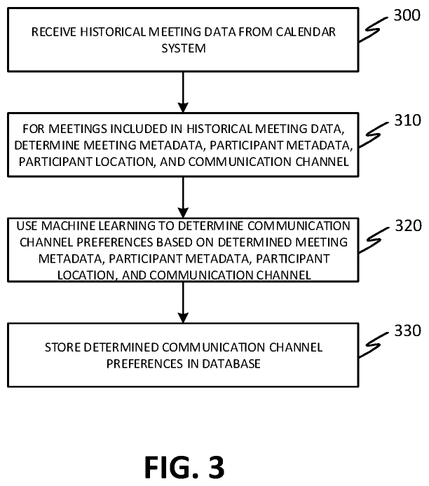

FIG. 3 depicts a flowchart of an exemplary method for determining communication channel preferences that is performed by the communication channel determiner program module 210 of the computer server 205 in accordance with aspects of the invention. The steps of the method are performed in the environment of FIG. 2 and are described with reference to the elements shown in FIG. 2.

At step 300, the computer server 205 receives historical meeting data from the calendar system 225. In embodiments, step 300 comprises the communication channel determiner program module 210 of the computer server 205 receiving the historical meeting data from the calendar system program module 230 of the calendar system 225. In embodiments, the historical meeting data includes information about meetings scheduled using the calendar system 225 for dates falling within a predetermined amount of time in the past (e.g., within the previous 3 months, 6 months, 1 year, etc.).

Still referring to FIG. 3, at step 310, the computer server 205, for meetings included in the historical meeting data received at step 300, determines meeting metadata, participant metadata, participant location, and a communication channel. In embodiments, step 310 comprises the communication channel determiner program module 210 of the computer server 205 determining the meeting metadata, the participant metadata, the participant location, and the communication channel. In particular, in embodiments, the meeting metadata determined by the communication channel determiner program module 210 includes a title of the meeting (e.g., from a title field in a meeting invitation), meeting details (e.g., a description from a body field in the meeting invitation), and available communication channels (e.g., communication channels offered in the meeting invitation, such as a meeting room, a call in number, etc.).

Still referring to step 310, in embodiments, the participant metadata determined by the communication channel determiner program module 210 includes information about roles and responsibilities of each of the meeting participants in the organization. In embodiments, the communication channel determiner program module 210 requests and receives information about roles and responsibilities (e.g., designer, program manager, etc.) of each of the meeting participants from the organizational structure program module 240 of the organizational structure 325. Additionally, in embodiments, the participant metadata determined by the communication channel determiner program module 210 includes metadata about other calendar events for each of the meeting participants.

Still referring to step 310, in embodiments, the participant location determined by the communication channel determiner program module 210 includes a location of a participant who is invitee as compared to the location of a participant who is the inviter. In embodiments, the communication channel determiner program module 210 deduces the location of the participant based on other events in the participant's calendar, as determined using the data received from the calendar system 225. In an example, a participant that has an adjacent calendar event that is a customer visit at a customer's location that is 50 miles away from a company's office, the communication channel determiner program module 210 deduces that the participant is offsite and not at the company's office for a meeting that takes place 30 minutes before the customer visit as the customer's location. In embodiments, the communication channel determiner program module 210 also deduces location based upon use of web conference tools (e.g., did the participant join by phone only or did the participant also use a screenshare feature).

Still referring to step 310, in embodiments, the communication channel determined by the communication channel determiner program module 210 includes a communication channel used by each of the meeting participants (e.g., a communication channel selected from the available communication channels specified in the meeting metadata).

Still referring to FIG. 3, at step 320, the computer server 205 uses machine learning to determine communication channel preferences based on the meeting metadata, the participant metadata, the participant location, and the communication channel determined at step 310. In embodiments, step 320 comprises the communication channel determiner program module 210 of the computer server 205 applying machine learning techniques including natural language processing to determine the communication channel preferences using the meeting metadata, the participant metadata, the participant location, and the communication channel determined at step 310.

Still referring to step 320, in particular, in embodiments, the communication channel determiner program module 210 uses machine learning techniques to determine communication channel preferences based on associations between meeting metadata, participant metadata, participant locations, and communication channels. In an example, in embodiments, the communication channel determiner program module 210 uses machine learning techniques including natural language processing to determine that a meeting with a single invitee and a title that contains the term “1:1” should be performed in person. In another example, in embodiments, the communication channel determiner program module 210 uses machine learning techniques to determine that a particular invitee always chooses a telephone conference as the communication channel for meetings that start before 9 a.m.

Still referring to FIG. 3, at step 330, the computer server 205 stores the communication channel preferences determined at step 320 in the database 245. In embodiments, step 330 comprises the communication channel determiner program module 210 of the computer server 205 storing the communication channel preferences determined at step 320 in the database 245.

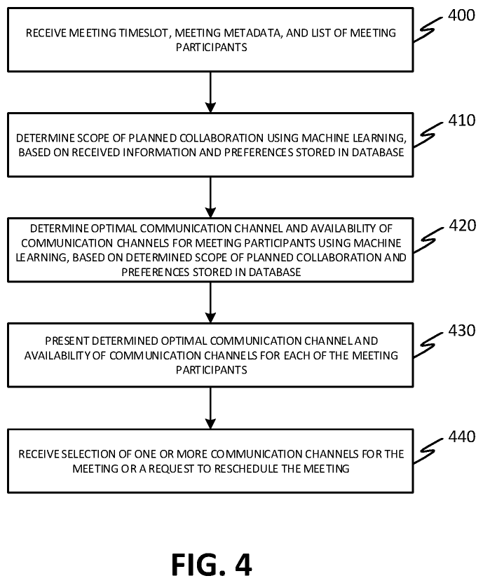

FIG. 4 depicts a flowchart of an exemplary method for determining a communication channel for a meeting that is performed by the communication channel determiner program module 210 of the computer server 205 using the communication channel preferences determined using the method described with respect to FIG. 3 in accordance with aspects of the invention. The steps of the method are performed in the environment of FIG. 2 and are described with reference to the elements shown in FIG. 2.

At step 400, the computer server 205 receives a meeting timeslot, meeting metadata, and a list of meeting participants. In embodiments, step 400 comprises the communication channel determiner program module 210 of the computer server 205 receiving the meeting timeslot, the meeting metadata, and the list of meeting participants from the calendar system user interface program module 220 of one of the client computing devices 215-1, 215-2, . . . , 215-n.

Still referring to step 400, in embodiments, a user of one of the client computing devices 215-1, 215-2, . . . , 215-n uses a user interface provided by the calendar system user interface program module 220 to create an invitation for a new meeting. In embodiments, an option is provided in the user interface to determine an optimal communication channel for the new meeting. In response to the user selecting this option in the user interface, the calendar system user interface program module 220 sends a request to determine the optimal communication channel that includes the meeting timeslot, the meeting metadata, and the list of meeting participants to the communication channel determiner program module 210 of the computer server 205, either directly or via the calendar system program module 230 of the calendar system 225. In embodiments, the list of meeting participants includes a list of invitees for the new meeting (e.g., names, email addresses, usernames, and/or user ids, etc.) as well the meeting timeslot and the meeting metadata (e.g., description from a body field) included in the meeting invitation. In embodiments, the meeting metadata includes one or more hyperlinks for resources to be used during the meeting, such as a whiteboard application, web conference application, VR conference, or chat application.

Still referring to FIG. 4, at step 410, the computer server 205 determines a scope of a planned collaboration using machine learning, based on the information received at step 400 and the preferences stored in the database 245. In embodiments, step 410 comprises the communication channel determiner program module 210 of the computer server 205 automatically determining the scope of the planned collaboration using machine learning, based on the information received at step 400 and the preferences stored in the database 245. In particular, in embodiments, the communication channel determiner program module 210 uses natural language processing on the title of the meeting (from the title field in the meeting invitation) and the description from the body field in the meeting invitation, as well as the list of meeting participants and any hyperlinks for resources to be used during the meeting (included, for example, in the body of the meeting invitation), to determine the scope of the planned collaboration (e.g., a type of meeting such as a 1:1 meeting, project meeting, design review meeting, etc. as well as required resources such as a whiteboard application or VR equipment). Additionally, the communication channel determiner program module 210 uses the preferences stored in the database 245 to determine the scope of the planned collaboration based on meetings with similar meeting metadata.

Still referring to FIG. 4, at step 420, the computer server 205 determines an optimal communication channel and availability of communications channels for meeting participants using machine learning, based on the determined scope of the planned collaboration (from step 410) and the preference stored in the database 245. In embodiments, step 420 comprises the communication channel determiner program module 210 of the computer server 205 automatically determining the optimal communication channel and the availability of communications channels for meeting participants using machine learning, based on the determined scope of the planned collaboration (from step 410) and the preference stored in the database 245.

Still referring to step 420, in embodiments, the communication channel determiner program module 210 applies the learned preferences to determine available communication channels per meeting participant and determines which of the meeting participants have a viable communication channel available (i.e., a communication channel that allows for an effective meeting) based on the scope of the planned collaboration. In an example, the communication channel determiner program module 210 determines communication channels that are available for each of the meeting participants, based upon the preferences stored in the database 245 as well as information from the calendar system 225 regarding adjacent meetings on a participant's calendar, which are used to infer a location for the participant. Additionally, the communication channel determiner program module 210 determines which of the communication channels that are available for each of the meeting participants are viable (i.e., will permit an effective meeting) based on the scope of the planned collaboration determined at step 410 and the roles and responsibilities of the meeting participants. In embodiments, the communication channel determiner program module 210 determines the roles and responsibilities of the meeting participants by requesting and receiving information about the roles and responsibilities (e.g., designer, program manager, etc.) of each of the meeting participants from the organizational structure program module 240 of the organizational structure 325.

Still referring to step 420, in an example, viable communication channels for a designer in a design meeting may include an in-person meeting and a web conference, while viable communication channels for a program manager in the design meeting may also include a telephone conference. In embodiments, the communication channel determiner program module 210 determines the optimal communication channel(s) based on one or more viable communication channels that are available for all of the meeting participants.

Still referring to FIG. 4, at step 430, the computer server 205 presents the determined optimal communication channel and availability of communication channels for each of the meeting participants. In embodiments, step 430 comprises the communication channel determiner program module 210 of the computer server 205 causing the calendar system user interface program module 220 on one of the client computing devices 215-1, 215-2, . . . , 215-n to present, on a user interface, the optimal communication channel(s) determined at step 420 as well as the availability of communication channels for each of the meeting participants determined at step 420. In embodiments, the calendar system user interface program module 220 provides a visual indication on the user interface regarding which communication channels were determined to be viable by the communication channel determiner program module 210 at step 420. Additionally, in embodiments, the communication channel determiner program module 210 causes the calendar system user interface program module 220 on one of the client computing devices 215-1, 215-2, . . . , 215-n to highlight meeting participants that have available a viable communication channel, as determined at step 420. In embodiments, the communication channel determiner program module 210 also causes the calendar system user interface program module 220 on one of the client computing devices 215-1, 215-2, . . . , 215-n to provide an indication regarding the availability of the meeting participants at the meeting time.

Still referring to FIG. 4, at step 440, the computer server 205 receives a selection of one or more communication channels for the meeting or a request to reschedule the meeting. In embodiments, step 440 comprises the communication channel determiner program module 210 of the computer server 205 receiving, from the calendar system user interface program module 220 on one of the client computing devices 215-1, 215-2, . . . , 215-n, a selection from a user (meeting organizer) of one of the communication channels presented at step 430. The meeting organizer may select the optimal communication channel determined at step 420. In embodiments, the optimal communication channel is a lowest common denominator channel, which is a channel that is determined to be a viable communication channel at step 430 and that is available for all of the meeting participants. In other embodiments, the meeting organizer may select multiple communication channels (e.g., in person meeting and web conference) that were determined to be viable (e.g., for a particular participant) at step 420. In embodiments, instead of receiving a selection of a communication channel, the meeting organizer may also request to reschedule the meeting (e.g., if no optimal communication channel is available). In response to receiving the request to reschedule the meeting, the communication channel determiner program module 210 suggests a new meeting time when one or more optimal communication channels are available for all meeting participants.

Still referring to step 440, in embodiments, in response to the communication channel determiner program module 210 receiving the selection of the communication channel(s) for the meeting from the calendar system user interface program module 220, the communication channel determiner program module 210 causes the calendar system program module 230 to send meeting invitations to the participants. In other embodiments, the calendar system user interface program module 220 sends the selection of the communication channel(s) directly to the calendar system program module 230, which then sends meeting invitations to the participants.

In an example, for a project meeting, the communication channel determiner program module 210 determines that two meeting participants are traveling at that time, with only audio access, while three meeting participants are in a lab at an office. In this case, the communication channel determiner program module 210 suggests booking a meeting room for the three people who are in the lab at the office and suggests a telephone conference for the two people on the road.

In another example, a manager has 1:1 meetings which are typically conducted using telephone conferences. However, the manager is currently scheduling a meeting with the title “face to face”, which is not typically included in the meeting titles. In this case, the communication channel determiner program module 210 suggests a time slot where the employee is most likely to be in the lab and available for an in-person meeting.

In another example, a design team schedules a meeting with the title “design review”, which contains a link to an online whiteboard application. In response to the communication channel determiner program module 210 determining that two people are traveling in a car at that time, the communication channel determiner program module 210 determines that no optimal communication channel is available and suggests a new time, where everybody is in front of a computer, for the meeting.

In another example, the communication channel determiner program module 210 determines based on organizational roles and responsibilities that invitees with role of project manager do not need to have online whiteboard application access during the meeting and are able to contribute effectively using a telephone conference. In this case, for meeting participants having the role of project manager, the communication channel determiner program module 210 determines that a telephone conference is a viable communication channel.

Accordingly, it is understood from the foregoing description that embodiments of the invention provide a method for determining an optimal resource in a social collaboration application, the method comprising: using a preselected time slot (manual or automated selection) wherein the best availability of the participant is selected; using collaboration metadata such as participants (inviter and invitee) metadata or metadata of the use and availability of resources; defining the scope of a planned collaboration using machine learning based on the metadata; defining the best available resource by using an additional analysis of the metadata wherein the selected resource fits best to the scope of the planned collaboration; presenting a result list to one of the participants (inviter); choosing one or more resources out of the result list; triggering the invitation of the participants (manual or automatically) and the selected resources, including adapting the time slot of the meeting, if a viable resource is not available.

Additionally, it is understood from the foregoing description that embodiments of the invention provide for automatically creating a database in the background with the metadata; using metadata including all available data about the participants and the resources in a connected computer system, social information, etc.; using metadata including the use of the resources by the participants when in another configuration; using metadata about participants including roles and responsibilities of participants in and contributions to a particular meeting and which resources are needed to fulfill this; grouping of participants depending on a selection by the inviter or a task or a project; and self defining the participants/resources by a task or a name or a project.

In embodiments, a service provider could offer to perform the processes described herein. In this case, the service provider can create, maintain, deploy, support, etc., the computer infrastructure that performs the process steps of the invention for one or more customers. These customers may be, for example, any business that uses cloud computing technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a computing device, information about a meeting;
determining, by the computing device, a scope of planned collaboration using the received information about the meeting;
determining, by the computing device, at least one communication channel for the meeting based on the determined scope of planned collaboration; and
presenting, by the computing device, the determined at least one communication channel for the meeting.

2. The method according to claim 1, wherein the received information about the meeting comprises a meeting timeslot, meeting metadata, and a list of meeting participants.

3. The method according to claim 2, wherein the meeting metadata includes a title in a title field of a meeting invitation and a description in a body field of the meeting invitation.

4. The method according to claim 1, wherein the determining the scope of planned collaboration further comprises using machine learning including natural language processing and a database of communication channel preferences.

5. The method according to claim 1, wherein the determining the at least one communication channel for the meeting further comprises using machine learning including natural language processing and a database of communication channel preferences.

6. The method according to claim 1, wherein the presenting the determined at least one communication channel for the meeting comprises highlighting meeting participants on a user interface that have available the determined at least one communication channel.

7. The method according to claim 1, further comprising:
receiving, by the computing device, a selection of one of the at least one communication channel; and
sending, by the computing device, a meeting invitation including the selected one of the at least one communication channel.

8. A computer program product comprising:
one or more computer readable storage media, and program instructions collectively stored on the one or more computer readable storage media, the program instructions comprising:
program instructions to receive historical meeting data from a calendar system;
program instructions to, for each meeting in the historical meeting data, determine a meeting timeslot, meeting metadata, and meeting participants;
program instructions to determine communication channel preferences using the meeting timeslot, the meeting metadata, and the meeting participants for each meeting in the historical meeting data; and
program instructions to store the determined communication channel preferences in a database.

9. The computer program product according to claim 8, wherein the meeting metadata includes a title in a title field of a meeting invitation and a description in a body field of the meeting invitation.

10. The computer program product according to claim 8, wherein the determining the communication channel preferences comprises using machine learning including natural language processing.

11. The computer program product according to claim 8, wherein the determining the communication channel preferences comprises determining locations of the meeting participants.

12. The computer program product according to claim 8, wherein the determining the communication channel preferences comprises determining communication channels used by the meeting participants.

13. The computer program product according to claim 8, wherein the historical meeting data includes information about meetings scheduled using a calendar system on dates falling within a predetermined amount of time prior to a present date.

14. A system comprising:
a hardware processor, a computer readable memory, and one or more computer readable storage media associated with a computing device;
program instructions to receive information about a meeting;
program instructions to determine a scope of planned collaboration using the received information about the meeting;
program instructions to determine at least one communication channel for the meeting based on the determined scope of planned collaboration; and
program instructions to present the determined at least one communication channel for the meeting,
wherein the program instructions are stored on the one or more computer readable storage media for execution by the hardware processor via the computer readable memory.

15. The system according to claim 14, wherein the received information about the meeting comprises a meeting timeslot, meeting metadata, and a list of meeting participants.

16. The system according to claim 15, wherein the meeting metadata includes a title in a title field of a meeting invitation and a description in a body field of the meeting invitation.

17. The system according to claim 14, wherein the determining the scope of planned collaboration further comprises using machine learning including natural language processing and a database of communication channel preferences.

18. The system according to claim 14, wherein the determining the at least one communication channel for the meeting further comprises using machine learning including natural language processing and a database of communication channel preferences.

19. The system according to claim 14, wherein the presenting the determined at least one communication channel for the meeting comprises highlighting meeting participants on a user interface that have available the determined at least one communication channel.

20. The system according to claim 14, further comprising:
program instructions to receive a selection of one of the at least one communication channel; and
program instructions to send a meeting invitation including the selected one of the at least one communication channel.
